(19) United States
(12) Patent Application Publication
(10) Pub. No.: US 2013/0148932 A1
(43) Pub. Date: Jun. 13, 2013

(54) COLD TEMPERATURE-RESISTANT CHLOROPRENE CASING MIXTURE

(71) Applicants: Christian Cornelissen, Rodgau (DE); Armin Niehaus, GE Venlo (NL)

(72) Inventors: Christian Cornelissen, Rodgau (DE); Armin Niehaus, GE Venlo (NL)

(21) Appl. No.: 13/558,635

(22) Filed: Jul. 26, 2012

(30) Foreign Application Priority Data
Aug. 16, 2011 (EP) 11 306 045.3

(51) Int. Cl. H01B 3/30; G02B 6/00

(52) U.S. Cl. CPC H01B 3/30; G02B 6/00
USPC 385/100; 524/773; 427/120; 427/163.2; 174/110 SR

(57) ABSTRACT

A casing mixture for a cable is provided having chloroprene with fillers and additives, particularly processing aids and softeners, as well as a cross-linking system, adhesion promoters, stabilizers, anti-aging agents, optionally coloring agents, which results after cross-linking in cold resistant and cold elastic vulcanizates which are suitable for extra heavy duty applications, for example, according to CSA Standard C22.2 No. 96-09 for moving lines for energy supply.

### RELATED APPLICATION

This application claims the benefit of priority from European Patent Application No. 11 306 045.3, filed on Aug. 16, 2011, the entirety of which is incorporated by reference.

### BACKGROUND

### Field of the Invention

The invention relates to a cold temperature-resistant chloroprene casing mixture for cables which, after cross-linking, produces cold temperature-proof and cold temperature elastic vulcanizate products which are particularly suitable for extra heavy duty applications, for example, according to CSA Standard C22.2 No. 96-09 for moving lines for energy supply. Correspondingly, the invention relates particularly to cables having a casing of the cross-linked mixture, and a method for manufacturing cables with the casing mixture. The casing mixture according to the invention is prepared on the basis of chloroprene which is present optionally in mixture with at least one additional polymer, wherein the polymer component consists preferably of chloroprene.

The casing mixture forms casings which are highly resistant to oil and mechanical load, particularly to abrasion. Moreover, casings of this casing mixture have a high thermal resistance, have good weather-resistance, for example, good UV and ozone resistance and, preferably offer the possibility for light color adjustments. For the purpose of the invention, cables comprise electrical and optical cables and lines. Another advantage of this casing mixture is the fact that it can be processed well, even on conventional extrusion plants which are used for producing cables. In addition to the high resistance of the cross-linked casing mixture, the invention also relates to the use of cables and lines as energy cables and/or control lines in mining, and for land and water vehicles.

The casing mixture is distinguished by a high load bearing capacity of the casings manufactured by the mixture, for example, a high cold elongation, particularly of at least 30% at −50° C., preferably in combination with a modulus 200 (Mod 200) of at least 4 to at least 5 N/mm².

### OBJECTS AND SUMMARY

It is the object of the invention to make available a casing mixture on the basis of chloroprene which is suitable for heavy mechanical loads also at low temperatures. Cables with a casing of the casing mixture should be usable for use at ambient temperatures of −50° C.

The invention meets this object with the features of the Claims, and particularly with a casing mixture or a cable which has the cross-linked casing mixture, particularly an outer casing. The casing mixture contains chloroprene (poly(2-chloro-1,3-butadiene) as polymer basis, particularly chloroprene having a Mooney Viscosity (1+4) 100° C. of 49±5MU, for example, in accordance with ISO 289/ASTM D 1646. The chloroprene preferably has a chlorine content of 40%.

The casing mixture has or consists of chloroprene as the cross-linkable organic polymer with the mentioned fillers and additives, particularly not polymerizable additives, for example, processing agents and softeners, as well as a cross-linking system which particularly includes a cross-linking agent and/or vulcanization accelerator, optionally a retarder and an activator (preferably ZnO), as well as adhesion promoters. Preferred additives are stabilizers, anti-aging agents, and optional coloring agents, preferably with a brightener. The mixture contains as filler, silica, preferably with a high specific surface area. The high specific surface area of the silica is preferably at least 170 square m/g.

The casing mixture according to the invention is distinguished by the fact that, after cross-linking, it has a balanced combination of properties which make it suitable for use in the case of high mechanical loads, even at low temperatures, especially good cold properties, for example, a cold elongation according to EN 60811-1-4 at −50° C. of at least 30%, more preferred at least 40%, even more preferred at least 50%, especially preferred of at least 60%, preferably in combination with a high weather resistance, for example, the stability in the Ozone Test according to DIN VDE 0472, part 805, Examination Type B, a very good thermal resistance for example, in hot air aging over 7 d at 100° C. according to CSA Standard 022.2 No. 96-09, and a high mechanical load bearing capacity similar to the mixture type 5GN5 according to DIN VDE 0207, part 21, preferably in combination with a high abrasion resistance. The casing mixture has particularly a high rupture elongation according to EN 60811-1-4 at −50° C. of at least 30%, particularly a high tear propagation resistance, as well as a good oil resistance, for example, against contacting with mineral oil IRM 902. The casing mixture according to the invention additionally meets the requirements for extra heavy duty cables according to CSA Standard C22.2 No. 36-03 for movable lines for energy supply.

The casing mixture additionally has in the non-cross-linked state a good processing capability, so that a method for manufacturing cables and lines with a casing of the cross-linked casing mixture can be carried out with the use of conventional kneaders and extruders.

These properties make the cross-linked mixture suitable especially for use as a casing of cables and lines which are configured or equipped for a movable use at temperatures of up to −40° C., for example, for use for lines to movable machine parts, or are configured for the fixed placement up to −50° C., or are equipped for use as fixedly placed lines up to −50° C.

Correspondingly, the invention relates to a method for manufacturing cables or lines by extrusion of the casing mixture with subsequent cross-linking, wherein the cables or lines are distinguished by the particular combination of properties with cold properties of the mixture composed of the casing mixture and, therefore, are particularly configured for the use as low temperature lines with high mechanical load bearing capacity.

The casing mixture according to the invention includes or consists of
100 phr chloroprene, which preferably contains 40% chlorine,
stabilizer, preferred of 3-7 phr, more preferred to 4-5 phr, for example, MgO,
aging protection agent, preferably to 3-7 phr, more preferred 4-6 phr,
optional color pigments, preferably technical soot, preferably with a specific surface area of 40 square m/g and a structure (OAN) of 120 ml/100 g, particularly 1-3 phr, preferably 2 phr,
a cross-linking system,
adhesion promoter, particularly 5.2-12.2 phr, more preferred 7.2-10.2 phr,
processing aids, particularly 8-15 phr, preferably 10-13 phr,
mineral filler, preferably calcinated or pyrogenic silica, preferably with high specific surface area, 40-55 phr, preferably 43-52 phr, more preferred 47-50 phr, and
5-10 phr softener, preferably softener with solidification point smaller than −60° C., particularly 4-10 phr, preferably 6-8 phr, for example, Bis(2-ethylhexyl)adipat, Di-2-ethylhexyladipat and/or dioctyladipat.

The parts stated in the polymer mixtures are to be understood to be as phr (parts per hundred rubber), i.e. the parts by weight of the ingredients are related to 100 parts per weight of polymer in the mixture.

Anti-aging agents may be or consist of, for example, pentaerythritol-bis(tetrahydrobenzaldehydacetal), particularly to 1-2 phr, preferably 1.5 phr antioxidants particularly to 0.7-1.3 phr, preferably 1 phr, for example, a diphenyl compound, and/or a bisphenyl compound, particularly to 1.3-2.7 phr, preferably to 2 phr, for example, 2,2′-methylenebis[6-(1.1-dimethyethyl)-4-methylphenol.

Processing aids may be or consist of, for example, protective ozone wax, preferably to 3-6 phr, more preferred 5-7 phr stearic acid, particularly to 0-1 phr, and/or silicon oil and mixtures thereof, particularly to a total of 8-15 phr.

The cross-linking system may comprise or consist of particularly retardants, preferably 0.9-1.5 phr, preferably to 1.25 phr, for example, N,N′-ethylenethiourea, cross-linking agents/anti-aging agents, particularly to 1.4-2 phr, more preferred to 1.7 phr, for example, methylmercaptobenzimidazole which is contained, in particular to 70%, in elastomer binder and dispersing agent, as well as activator, particularly 4-6 phr, preferably 5 phr, for example, ZnO, and mixtures thereof.

Adhesion promoters may comprise or consist of preferably a total of 5.2-12.2 phr, more preferred to 7.2-10.2 phr, triethanolamine and sulfur silane, preferably to 50% on wax carrier, and mixtures thereof.

### BRIEF DESCRIPTION OF THE DRAWINGS

The casing mixture according to the invention will now be described with the aid of sample mixtures and their mechanical properties, especially the high cold temperature resistance and cold, elasticity. In the drawing

FIG. 1 shows measurement values of the cold elongation of cross-linked casing mixtures at −50° C., and

FIG. 2 shows measurement values for Modulus 200 (Mod200) of cross-linked casing mixtures.

### DETAILED DESCRIPTION

Table 1 shows mixtures according to the invention. The mixture components were mixed in a standard cycle in a stage in a 2.8 L laboratory kneader with a filling factor of 0.7 and the mixing was finished on a laboratory rolling mill.

TABLE 1
Mixtures According to the Invention

| Contents (phr) | Mixture A | Mixture B |
|---|---|---|
| Chloroprene | 100 | 100 |
| Stabilizer (MgO) | 4 | 5 |
| Anti-aging Agent | 5.5 | 4.5 |
| Technical Soot | 2 | 2 |
| Cross-linking System Composed of | 8.15 | 9.15 |
| 1.2 phr Dibenzothiazyl Disulfide, | | |
| 1.25 phr N,N′-Ethylenethiourea, | | |
| 1.7 phr 70% Methyl mercaptobenzimidazole in | | |
| Elastomer Binder/Dispersing Agent, | | |
| 5 phr ZnO | | |
| Adhesion Promoters | 10.2 | 7.2 |
| Processing Aids (Ozone Protection | 12.5 | 10.5 |
| Wax, Paraffin, Stearic Acid) | | |
| Filler (Silica) | 47 | 50 |
| Softener (Dioctyl Adipate) | 6 | 8 |

A mixture of triethanolamine and sulfur silane was used as adhesion promoter. The rheological properties were measured in the casing mixture, the properties of the cross-linked casing mixture, particularly strength and cold properties were measured predominantly in steam cross-linked plates (for example, 150 s at 200° C.) which were manufactured of roiling skins. Several tests were carried out in extruded casings or hoses (20 mm diameter) which were also cross-linked in steam (150 s, 200° C.) as the conditions in proximity of the production. The properties of a mixture according to the invention are presented in the following. Table 2 in comparison to those of a comparative mixture of high quality which meets requirement profile 5GM5.

TABLE 2
Comparison of Properties of Casing Mixtures

| | | | | Measured Values | |
|---|---|---|---|---|---|
| Ser. | | | Target | | Acc. to the |
| Nr. | Properties | Dimension | Value | Comparison | Invention |
| 1. | Rheology | | | | |
| 1.1 | ML 1 + 4 100° C. | ME | | 42 | 53 |
| 1.2 | MS T5 121° C. | Minutes | | 17:31 | 13:20 |
| 1.3 | Rheometer 180° C t2 | min:sec | | 0:48 | 0:27 |
| | t90 | min:sec | | 6:38 | 8:12 |
| 2. | Properties | | | | |
| 2.1 | Modulus 200 (CSA-Standard | N/mm² | ≧4.8 | 2.7 | 5.3 |
| | C22.2 No. 96-09) | | | | |
| 2.2 | Tensile Strength | N/mm² | ≧16.5 | 17.1 | 17.3 |
| 2.3 | Rupture Elongation | % | ≧300 | 850 | 631 |
| 2.4 | Permanent Elongation | % | — | 45 | 30 |
| 2.5 | Shore A-Hardness/IRHD-Hardness | | — | 64/74 | 73/75 |
| 2.6 | Cold Elongation (EN 60811-1-4) | % | >30 | 5 | 62 |
| | at −50° C. | | | | |
| 2.7 | After Oil Aging | | | | |
| | 18 h; 121° C.; IRM-Oil 902 | | | | |
| | (CSA-Norm C22.2 Nr. 96-09) | | | | |
| | Remaining Tensile Strength | %* | ≧60 | 88 | 96 |
| | Remaining Rupture Elongation | %* | ≧60 | 85 | 86 |
| 2.8 | After Hot Air Aging | | | | |
| | 168 h; 100° C. | | | | |
| | (CSA-Standard C22.2 No. 96-09) | | | | |
| | Remaining Tensile Strength | %* | ≧50 | 86 | 95 |
| | Remaining Rupture Elongation | %* | ≧50 | 69 | 77 |

*Of Starting Value

The rheological results show that the mixture according to the invention has properties which are suitable for processing. The measured values and material tests of the cross-linked mixtures show that the casing mixture according to the invention has balanced mechanical properties and drastically better values at low temperatures. The resistance to oil aging and hot air aging is also significantly increased for the casing mixture according to the invention and, in combination with the cold properties, demonstrate the particular suitability of the casing mixture for extreme loads, particularly for use as a moving casing up to −40° C. and as a stationary casing up to −50° C.

The cross-linked casing mixture according to the invention meets the requirements which, in accordance with CSA Standard C22.2 No, 96-09, are made of a casing for extra heavy duty cables, and particularly has a Modulus 200 of greater than 4.8 N/mm and a tensile strength of greater than 16.5 N/mm², and additionally has excellent cold properties, for example, a cold elongation according to EN 60811-1-4 at −50° C. which is significantly greater than 30% and a property profile similar to Level 5GM5 according to DIN VDE 0207-21.

Preferably, cross linked casing mixtures according to the invention have in combination a Modulus 200 of at least 4.8 N/mm², preferably of at least 5.0, a tensile strength of at least 16.5 N/mm², preferably of at least 17 N/mm, more preferred at least 17.3 N/mm², a Shore A-Hardness of at least 70, preferably of at least 73, IRHD Hardness of at least 70, preferably of at least 75, a cold elongation according to EN 60811-1-4 at −50° C. of at least 30%, more preferred at least 50%, particularly 60%, even more preferred at least 62%,

in combination with a remaining tensile strength after oil aging for 18 h at 121° C. in IRM oil 902 of at least 60%, preferably at least 90%, more preferred of at least 96%, and a remaining rupture elongation of at least 60%, preferably at least 80%, more preferred at least 86%,
preferably in combination with a remaining tensile strength after hot air aging for 168 h at 100° C. of at least 50%, preferably at least 90%, more preferred at least 95%, and a remaining rupture elongation of at least 50%, preferably 70%, more preferred at least 77%,
preferably in combination with a rupture elongation of at least 300%, preferably of at least 600%, more preferred at least 630%, of a permanent elongation of at most 30%,
preferably without the formation of cracks after ozone aging according to VDE 0472 Part 805, Examination Type B.

The values for the cold elongation at −50° C. were determined for the comparative mixture of Table 2 (Mixture 1) and other comparative mixtures (Mixtures 2 to 4) as well as for the mixtures according to the invention (Mixture 5). The measurement results demonstrate the drastically better cold elongation of the mixtures according to the invention.

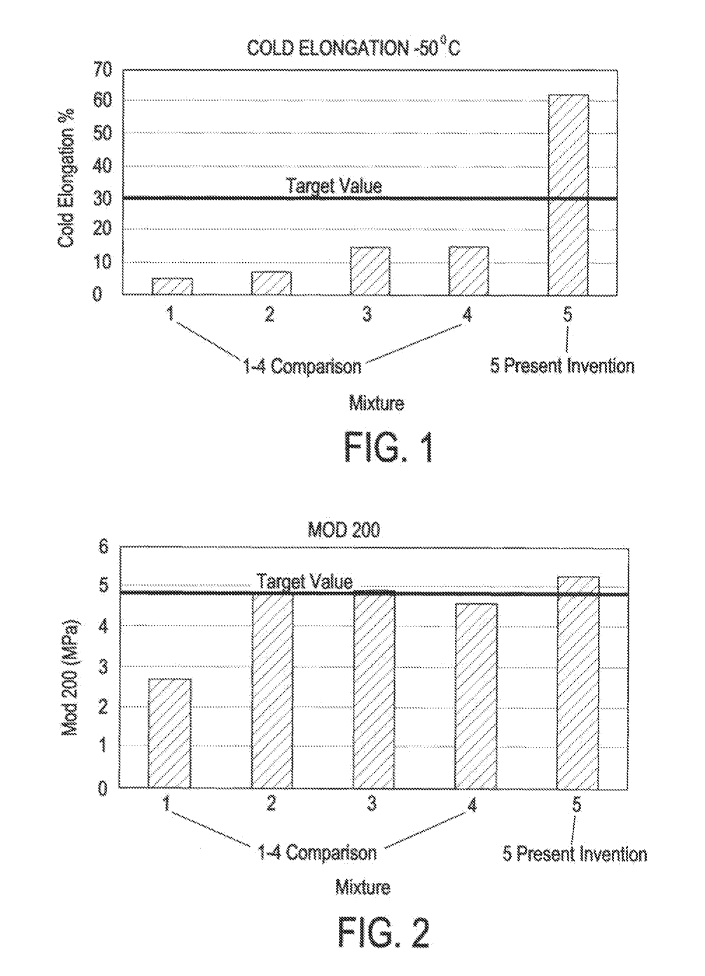

The values for Modulus 200 shown in FIG. 2 were determined for the same cross linked mixtures as they were used for the measurements of FIG. 1. Here the Mixtures 5 according to the invention have the highest value for the Modulus 200.

1. A Cross linkable polymer mixture for use as casing mixture for electrical and/or optical cables and lines, said cross linkable polymer mixture having a content of chloroprene, said cross linkable polymer mixture comprising:
100 phr chloroprene, or a mixture of chloroprene and a further polymer which is a polar unsaturated rubber with a content of at most 30 phr;
3 to 7 phr stabilizer;
3 to 7 phr anti-aging agent;
0 to 7 phr coloring agent;
a cross linking system;
5.2 to 12.2 phr adhesion promoter;
8 to 15 phr processing aids;
40 to 55 phr mineral filler; and
5 to 10 phr softener.

2. The polymer mixture according to claim 1, wherein the mineral filler is either one of calcined or pyrogenous silica.

3. The polymer mixture according to claim 1, wherein the softener is a softener or a mixture of several softeners with a solidification point lower than −60° C.

4. The polymer mixture according to claim 1, wherein the adhesion promoter contains any one of triethanolamine, sulfur silane or both.

5. The polymer mixture according to claim 1, wherein the mineral filler silica has a specific surface area of at least 170 squarem/g.

6. The polymer mixture according to claim 1, wherein the stabilizer is MgO, the anti-aging agent contains pentaerythritol bis(tetrahydrobenzaldehyde acetal), a diphenyl compound and/or a bisphenol compound, and the cross linking system includes a retarder, a cross linking agent and/or a vulcanization accelerator, a cross linking compound and an activator.

7. The polymer mixture according to claim 1, wherein the processing aid is a mixture of ozone protection wax, paraffin, stearic acid and/or silicon oil.

8. The Polymer mixture according to claim 1, wherein the mixture has, after cross linking, a cold elongation according to EN 60811-1-4 at −50° C. of at least 30%.

9. An electrical and/or optical line or cable, wherein an outer casing of a polymer mixture according to claim 1.

10. A Method of preparing an electrical and/or optical line or cable, said method comprising the step of:
applying a polymer mixture according to claim 1 as a cold resistant casing.

11. Method of manufacturing a line or a cable said method comprising the steps of:
extruding a polymer mixture around at least one electrical and/or optical conductor; and
cross-linking the polymer mixture, wherein the polymer mixture is a mixture according to claim 1 which is made by mixing its components, is extruded and subsequently cross-linked.

12. Method according to claim 11, wherein the mixture is either one of extruded into a casing of the line or the cable and is cross-linked by heating.
